(19) United States
(12) Patent Application Publication
(10) Pub. No.: US 2008/0071808 A1
(43) Pub. Date: Mar. 20, 2008

(54) Internet Identity Manager

(75) Inventors: Dick C. Hardt, Vancouver (CA); Keith Grennan, Vancouver (CA)

Correspondence Address: PERLEY-ROBERTSON, HILL & MCDOUGALL LLP, 1400-340 Albert Street, OTTAWA, ON, K1R 0A5, US

(73) Assignee: SXIP IDENTITY CORPORATION, Vancouver (CA)

(21) Appl. No.: 11/855,350

(22) Filed: Sep. 14, 2007

Related U.S. Application Data
(60) Provisional application No. 60/825,643, filed on Sep. 14, 2006.
(60) Provisional application No. 60/828,839, filed on Oct. 10, 2006.
(60) Provisional application No. 60/829,017, filed on Oct. 11, 2006.
(60) Provisional application No. 60/868,410, filed on Dec. 4, 2006.
(60) Provisional application No. 60/866,194, filed on Nov. 16, 2006.

(51) Int. Cl. G06F 17/30

(52) U.S. Cl. 707/100; 707/E17.001

(57) ABSTRACT

An identity agent stores identity information for a user and provides form filling functionality to online forms using users user generated mapping system to determine a map between the requested and stored information. The maps uses to associate the stored information to the requested information are generated by users of the identity agent and are shared as a community endeavor which provides a distributed mapping effort. The identity information can be stored as a persona, allowing a plurality of personas to be used by a user.

### CROSS REFERENCE TO RELATED APPLICATIONS

This application claims the benefit of U.S. Provisional Applications No. 60/825,643 filed Sep. 14, 2006; 60/828,839 filed Oct. 10, 2006; 60/829,017 filed Oct. 11, 2006; 60/868,410 filed Dec. 4, 2006; and 60/886,194 filed Jan. 23, 2007, which are all incorporated herein by reference in their entirety.

### FIELD OF THE INVENTION

This invention relates generally to identity managers for use in online environments.

### BACKGROUND OF THE INVENTION

In an online environment, using a network such as the Internet, a user is often required to provide identity information to subscribe or register for a service.The information required by one site may be different from the information required by another site. Similarly, the information that a user wishes to provide to a first site may differ from the information the user wants to release to the second site.

Many users find the task of filling in forms repetitive. Sites that request large amounts of information often find that the quality of the information collected is poor, as users do not provide accurate information in longer forms.

To allow a user to bypass filling in a form, form-filling applications have been developed. These applications allow a user to click a button to fill in a form. A form is usually generated using HTML. Each field in the form is provided a unique identifier in the HTML. The form filling application either guesses the content that should go into the form fields based on the field identifier embedded in the HTML, or determines the content for each field based on a known mapping of the form. Where mappings for forms exist and are used, they are centrally stored and are designed by the providers of the form filling applications.

As the number of forms on the Internet is constantly increasing, mapping based filling applications are limited in how quickly a form mapping can be provided by the ability of the developers of the tool to find forms and generate mappings for them. Best-guess based form-filling applications provide immediate access to a form, but the mapping is often incorrect or incomplete. When a form is designed using field identifiers that are obscure or have names that are not logically linked to the requested content, guess-based form filling provides an unsatisfactory mapping.

Many users find that form filling applications are of limited use for the above noted reasons. Furthermore, many users raise other issues including the lack of ability to store different sets of user information based on personas. A user may wish to provide one set of information to a site dedicated to online gaming, while wanting to provide a second set of information to online merchants, and a third set of information to another group of sites. The different information sets may include different addresses, email addresses, and phone numbers. Each of these sets of information defines a persona, and an individual often presents differing personas at different times

Therefore, it is desirable to provide a mechanism to permit users to provide persona based information sets to forms in an accurate manner.

### SUMMARY OF THE INVENTION

It is an object of the present invention to obviate or mitigate at least one disadvantage of the prior art.

In a first aspect of the present invention, there is provided an identity agent for use in electronic communications. The identity agent comprises a browser interface, an identity store interface, a mapping table interface and an analysis engine. The browser interface is used for communication with a web browser. The identity store interface is used for access to an identity store containing user identity information. The mapping table interface is for communicating to at least one of a plurality of mapping tables. The mapping table interface is used to request mappings from a mapping table for any form received by the browser, and to transmit to a mapping table any mapping generated by the identity agent that associates a field in a form to an element of an identity schema. The analysis engine is used to determine if a page received by the browser contains a form, to request mappings from the mapping table for any form received by the browser, for filling in forms with user identity information that is determined in accordance with received mappings, and for generating mappings for forms not in the mapping table.

In embodiments of the first aspect of the present invention, one of the plurality of mapping tables can be stored locally. In other embodiments the analysis engine can include a mapping generator. The mapping generator can generate mappings between the fields of an obtained form and elements of the identity schema. The mapping can be based on an analysis of the information input by a user into form fields. The mapping can also be based on the obtained form and a name associated a field in the form.

In a further embodiment of the present invention, the identity information can be organized as a series of personas, each persona having a unique set of identity information. The analysis engine can include a persona selector to allow the user to select one of the series of personas and provide the information associated with the selected persona to the form. The persona selector can include an identity management system persona selector for accessing identity information associated with a identity management system, and for presenting the accessed identity information to the user as a persona within the identity agent. The identity management system can be any of a number of systems including OpenID and InfoCard.

In another embodiment of the present invention, the analysis engine can include a user interface engine for indicating recognition of a form to the user through the browser. The user interface can include a translucent overlay over the form indicating the availability of a form mapping. The color of the overlay can be varied in accordance with the form mapping, so that, for example, a form that has been flagged as a potential phishing attempt can have a red overlay to alert the user. The translucent overlay can provide a quick pick list of personas, and can provide one-click functionality for small forms, with the possible entries provided in a list superimposed on the form field.

In yet a further embodiment, the analysis engine includes a password generation engine for generating a site-specific password for filling in password requests on forms. The password generation engine can include means to obtain a password from a user, associate the password obtained from the user with a password hint and provide the user the ability to select the password obtained from the user by displaying the associated password hint. The generated passwords can be stored by the password generation engine along with login information associated with the generated password.

In another embodiment, the mapping table can include a reputation based engine for evaluating maps received by the analysis engine. The analysis engine can also include means for displaying reputation information associated with a user who submitted a received mapping.

In a further embodiment, the identity agent can include a pseudonymous identity information generator interface. This interface alls the identity agent to receive pseudonymous identity information from a pseudonymous identity information generator and allows for the association of the received pseudonymous identity information with stored identity information. The pseudonymous identity information can be selected from a list including a pseudonymous email address, a pseudonymous credit card number, a pseudonymous postal address and a pseudonymous telephone number. The pseudonymous identity information can also be uniquely associated to the form.

In another embodiment of the present invention, the identity information stored in the identity store is obtained from a source selected from a list including a form completed by the user, electronic address books, data submitted to already mapped forms, and a browser auto-fill history. In a further embodiment, the obtained mapping can be a generic map that is not specific to the page received by the browser. In such a case, the generic map, or template, is applicable to a plurality of different pages.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram illustrating the interaction of the present invention with Internet elements; and

FIG. 2 is a block diagram illustrating an embodiment of the present invention as functional elements.

### DETAILED DESCRIPTION

The present invention is directed to identity agents for use in online environments such as the Internet.

Prior to the discussion of the present invention, the concept of a persona, as it relates to identity management and user identity information, should be explained. Prior art attempts at identity management are typically based on the idea that a user has a single set of identity data that can be provided to any requesting site. This is inconsistent with the reality of most users' experiences. A single user may have only one name, but often has multiple email addresses. The email addresses may denote work and personal contact points. Similarly, address information may vary along with telephone numbers and other contact information. Often users have unique sets of information that may include overlapping elements. Each set of information form the basis of a persona. A user may have a work persona based around an office email address, and office address and an office phone number in addition to an at-home persona using a personal email address, a residential mail address and a phone number. The user's biographic information (such as name, gender, date of birth, etc.) can be consistent across personas. A preferred alias can be stored in each profile so that a user can create accounts at different sites with different aliases as usernames depending on the persona used to create the account. By storing information sets as personas, the present invention allows a user to fill-in forms with information based on the preferred set of identity information that the user wishes to release.

To obtain the user identity information, a number of sources can be consulted. Many web browsers have an auto-fill history that is used to fill in already stored information. This history can be used to gather user identity information, as can information that the user provides to already mapped forms. Entries in an electronic address book identified by the user can form another source of data, as could a virtual business card, such as a vCard. Users can also be prompted to populate the schema using a form during the setup of an identity agent.

An identity agent stores user identity information and manages the release of the information. The release of the information is preferably done upon receipt of user approval for the release. The identity information associated with the selected information can be provided to the user for approval, and then provided to the requesting form. The identity agent obtains a mapping between the requested information and elements in a schema. The schema defines the structure used to store an overall listing of the information known about the user. Each schema element, such as name, postal or zip code, phone number and email address can be differentiated from each other by the element type. Furthermore, a personal can be created as a grouping of schema elements. Thus two different phone numbers can be associated with the same name in two different personas.

Forms are typically presented to a user on the Internet using HTML. An HTML based form makes use of a defined form field. The form field is associated with an identifier, which is unique on a per-form basis. This allows the form data to be submitted to the requesting site in a non-ambiguous manner. The form field can have one of a number of types. The field can be a free-form text entry field, it can be a drop down menu, or it can be a selection based menu. The field identifiers are not standardized, and are left to the determination of the designer. As such, a form may request a first name in a given form and identify the field as ‘fname’, while a second form may identify the same field as ‘firstname’, and a third form may identify the field as ‘001’. From this example, one can readily see why best-guess techniques cannot be relied upon to determine a mapping.

To determine the mapping of form fields to elements of the schema, the identity agent examines a mapping. The mapping indicates a relationship between a form field and an element in the identity schema. The mapping can be stored locally (either independently or as a local cache), embedded in the form itself, or on a central server. For the purposes of the following discussion, the central server scenario will be discussed. The identity agent requests a mapping from a central server using a data connection. When a mapping associated with the form is found, the identity agent provides the user with the ability to select personas. Mappings can either be associated to a specific form, or they can be template based for use on common forms, such as blog comment fields. If a template based mapping is obtained, an instantiation specific to the particular form can be created either dynamically by the identity agent or by the central repository. When a mapping is not found, the user is provided the option of defining a mapping for the form and uploading the mapping to the server, or bypassing the process and simply entering the information in as would otherwise be required. By allowing users to define mappings, the work of creating mappings is distributed. The distribution of the task reduces the wait time for a new mapping to be created. Mappings can undergo a validation process to determine their accuracy before they are presented to other users. As a user creates more a more mappings, a reputation can be established. The mappings of users with excellent reputations can be provided a simpler validation process than the one used for mappings generated by users without reputation information.

Distributing the creation of maps, and building a cooperative community allows for the creation of large numbers of mappings in a short period of time. The users community can also be provided the ability to edit existing mappings if an error is detected. Detected errors can adversely change a user's reputation. The reputation of users can be used as a gauge of whether or not an edit to a mapping should be immediately offered or if the edit should be held in reserve until validated by a central authority.

The operation and interaction of the identity agent will now be discussed with reference to the Figures. Reference is made below to specific elements and steps, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

An identity agent 100 is functionally paired to a website browser 102. The browser is controlled by a user, who can direct the browser to connect to different servers, such as site1 104 and site2 106. When identity agent 100 detects that a server has provided a form to browser 102, a determination of whether a mapping between form fields and elements of an identity schema has been embedded in the form is made. If no mapping has been embedded, identity agent 100 connects to mapping table 108. Mapping table 108 is typically remotely accessed, although a local cache of the data of mapping table 108 can be accessed locally in some implementations. If a mapping for the form provided by a server is found in mapping table 108 or embedded in the form, the mapping is read by identity agent 100. Identity agent 100 presents an interface to the user allowing the user to make use of the mapping and select a set of data associated with an persona stored in identity store 110.

Identity store 110 can be local or remote to the user, though to address privacy concerns, identity store 110 is typically a local identity repository. The data in identity store 110 may be backed up to an identity store backup 112 that is remote to the user. Identity data can be stored in an encrypted state. Identity store 110 is used to hold the identity information of a user according to a defined schema. Identity information is preferably organized as a number of sets, each defining a persona. The Identity Agent 100 accesses the identity store 110 to obtain the information associated with a selected persona that is required for filling in a form.

Identity information is organized according to a defined schema. Maps provide a pairing between form fields and elements in the identity schema. The relationship between a form field and a schema element must be unique to avoid ambiguity (e.g. a name field on a form should uniquely point to one of a first name, a last name or a full name, but not to more than one.)

When the user selects a persona, confirms the validity of the information and provides authorization for the release of the information, identity agent 100 submits the information to the site through browser 102.

From the perspective of the user, because the request for a mapping is done as the form is being rendered, the experience is seamless. Whenever a form is encountered the user is provided with an interface to the identity agent 100.

When a form is encountered that does not have a mapping, the identity agent 100 provides an interface to the user allowing the user either to directly enter the information required bypassing identity agent 100, or to create a mapping for the form. When the user creates a mapping, the user is presented the name of the fields in the form (preferably in the order that they appear on the page). The user is then prompted to associate a schema element with each field where possible. Users can be provided with the ability to indicate that a field cannot be mapped, or that a new schema element is required.

The identity agent can make use of best-guess algorithms to map schema elements to form fields, and then provide the user with the ability to confirm or refine the selections. This reduces the time that the user has to spend creating mappings, and provides a human check of the mapping.

After a user has defined a mapping, the identity agent 100 submits the data to the server through browser 102. User approval for the submission of the mapping can be sought prior to release of the mapping. The mapping is then added to the mapping table 108. New mappings may be held in a queue for a period of time to allow them to be vetted by an administrator. Alternatively, the mappings can be immediately made available and users can be provided with the ability to edit other user's mappings to correct errors in user-generated mappings.

If a user bypasses distinct form creation, the identity agent can be enabled to statistically analyze the data provided to a form. This analysis, in conjunction with the analysis performed by other identity agents on the same form, can be used as the basis for a mapping.

The interface provided to the user to indicate the availability of a mapping can, in some embodiments, be a translucent overlay on, or near the form. The coloration of the overlay can be used to provide information to the user about the site. In one example, the coloration of the overlay can be changed to indicate the suspicion that a site is a phishing site that is seeking user information for illicit uses. The translucent overlay can be placed a form, and can provide the user the ability to invoke identity agent 100. The overlay can be used to indicate whether a form mapping is available or if an opportunity to create a mapping is available. When used to indicate that a mapping is available, it can be used to either invoke an identity agent interface that provides a persona selector, and allows the user to selectively approve the release of each element of identity information, or it can be used to provide a persona selector that allows rapid selection of a persona. When a personal is selected, the relevant information associated with the persona is inserted into the forms, and the users is provided the ability to delete or modify entries prior to submitting the form.

In other embodiments, the interface provided to the user can be a small icon placed in the form field. When the user clicks on the icon, a persona selector can be provided. The persona selector can be provided as a series of translucent overlays, or can be provided in a separate window. When provided as a series of translucent overlays, the persona selector can function as a quick-pick selector. When a persona is selected, the information associated with the persona can be inserted into the form fields. The user can either delete the information that should not be submitted, or by clicking on the icon placed into each of the form fields, can select different information to be submitted for each field individually.

Forms mapped in the mapping tables 108, are preferably grouped by a form type. Where some forms are designed to obtain profile information (such as information required during an online purchase), other forms are used for registration at a site. One of the key differences between these form types is that a username and password pairing is generated during registrations. As different forms require different handling, the type of form can be provided by the user during the mapping process, can be determined by best-guessing or a combination thereof. The identity agent 100 can provide a randomly generated password, or can allow the user to enter her own password on a registration form. When the user enters a password, it is possible to associate that password with a password hint, so that in the future, the user can be provided with the chance to reuse the password with only the hint showing instead of the full password. In the password form field, the icon can be altered to indicate which password has been submitted. Random passwords can be created to offer a degree of security that is difficult for most users to match. Providing different random passwords to different sites also ensures that the compromise of a password at one site will not necessarily lead to the compromise of a password at another site.

When a username and password pairing are generated, it is preferable for the mapping to store the URL of the page that will request the username and password as a login. This information can then be stored by the identity agent 100 so that the user will immediately be able to login to the site. With the login page URL known, the user can use a randomly generated password at registration and not need to have a copy of the password to create a login mapping. This enables full password management, and allows a user to have different passwords at different sites, each password being difficult to guess due to its random nature. It is difficult for users to provide this degree of password security for themselves. Many passwords are easy to attack using social attacks, and it is rare for users to use different passwords at different sites, especially if the passwords are difficult to guess.

The identity agent 100 of the present invention can be an identity management system aware identity agent. This allows identity agent 100 to determine if a login page makes use of an identity management system. If such a system is detected, a persona dedicated to the identity management system can be employed. As an example, the identity agent can be OpenID-aware. When an OpenID compliant site is visited, the identity agent 100 need not request a mapping from mapping table 108, and instead can provide the credentials required for an OpenID login. The interface provided to the user by identity agent 100 can be altered to indicate that an identity management system login is requested.

The use of a client based identity agent in conjunction with a distributed identity system, such as OpenID, prevents a number of identity attacks that rely upon deceptively attempting to obtain user passwords and OpenID URIs. A local identity agent can be used to release the password only to a known OpenID provider, which will prevent the release of the information at a site that looks deceptively similar.

Certain forms require only a single data element, or a small set of data. These forms often request an email address, a postal code, or another simple release of data. If the form mapping identifies the form as such, identity agent 100 can automatically submit the information through browser 102, after the user selects the data for release from a quick pick menu, instead of allowing the user to view the filled form. This one-click experience allows small data sets, not used for registration, to be quickly submitted.

In one embodiment, the identity agent can communicate with pseudonymous email address generators, such as those disclosed in issued Canadian Patent No. 2,447,121, (the contents of which are incorporated herein by reference) to obtain pseudonymous email addresses for use on forms requesting email addresses. The identity agent can make use of an email address confirmation system to ensure that the user is associated with the email address that the pseudonymous email address redirects to. This allows users to sign up for services and provide email addresses to requesting sites, and maintain the ability to delete an email account if it is abused without detrimentally impacting on other logins.

In another embodiment, in place of a pseudonymous email address generator, a pseudonymous identity information generator can be used. A pseudonymous identity information generator creates mappings between generated identity information, such as phone numbers, addresses, and credit card numbers and identity information stored in the identity store. The generation of the pseudonymous address information typically requires storing the identity information with the pseudonymous identity information generator, and allowing a mapping that when processed by external processing servers (e.g. credit card processing systems) resolves the pseudonymous information to the stored information.

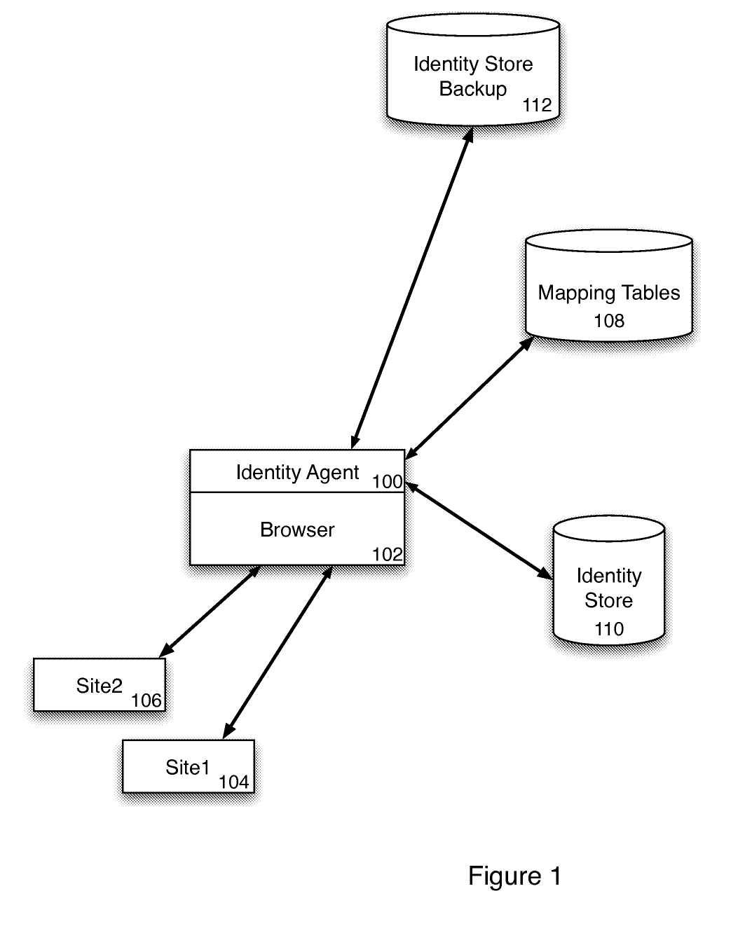

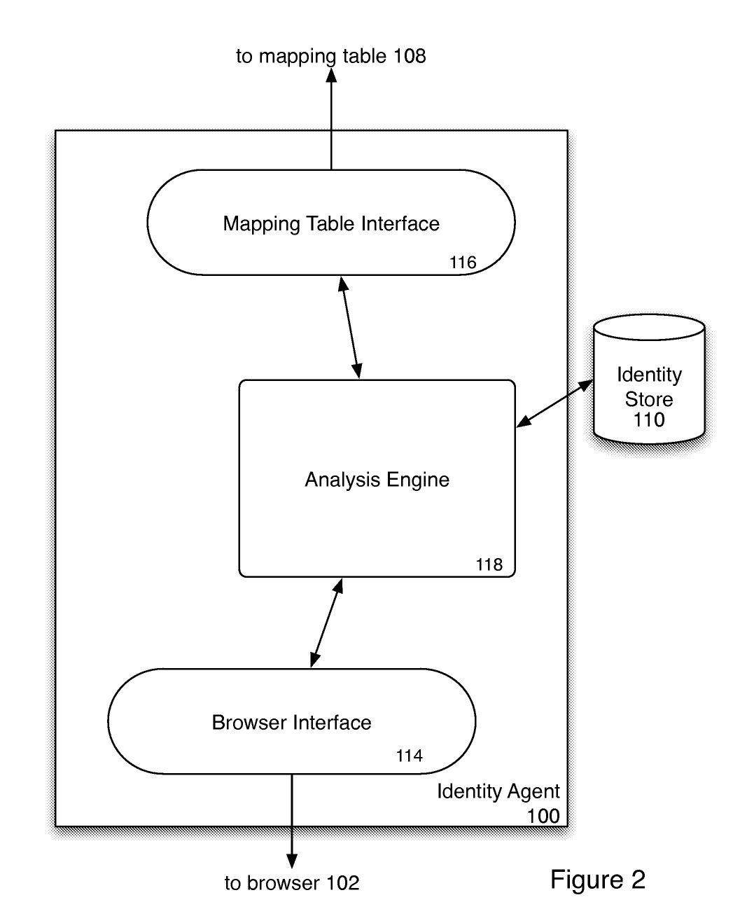

FIG. 2 illustrates an embodiment of the present invention instantiated as functional elements. One skilled in the art will appreciate that if implemented in software, functionality of the illustrated elements need not be distinct or discrete. The Identity Agent 100 is shown in FIG. 1 as connected to browser 102. The connection between these elements is provided by browser interface 114. Browser interface 114 may take advantage of publicly accessible application programming interfaces specific to a browser. If so desired, Identity agent 100 can be instantiated as a plugin or extension to an existing browser, or can be provided as a set of functions fully integrated into the browser. The connection to mapping table 108 is provided by mapping table interface 116 which can make use of existing communication protocols. The mapping table interface can communicate with the mapping table through the browser, in which case the functionality of the mapping table interface 116 can be integrated into the browser interface 114. Mapping table interface handles the requests for mappings, the responses thereto as well as the transmission of new mappings to the mapping table. Analysis engine 118 communicates to the browser 102 through the browser interface 114 and examines pages received by browser 102 from sites such as site1 104 and site2 106. When the examination of pages results in the determination that a form has been received, analysis engine 118 transmits a request for a mapping to mapping table 108 through mapping table interface 116. The selection of the persona and obtaining user consent for the release of data is a function of the analysis engine. User identity information is stored in Identity Store 110, which is shown here as discrete from the identity agent, but can be implemented as a contained element. The identity store houses the identity information, and is accessed by the analysis engine 118. The identity store can be local and stored on the same device or machine as the browser, it can be stored on a secured and portable device, or it can be remotely accessible to the identity agent 100. In some embodiments, elements of the identity store are provided by the browser, which has a username and password storage facility.

In operation, the user directs the browser 102 to site1 104 and retrieves a page having a form. Analysis engine 118 in identity agent 100 detects the form and issues a request to mapping table 108 through mapping table interface 116. The request contains the information required to identify the form, which may include the URL of the form, a form identification code, a list of the form fields, the destination to which the form data is sent, or any combination of the above. The mapping table 108 identifies the form as a known form, and transmits a mapping to identity agent 100. Analysis engine 118 receives the mapping, and presents the user with a persona selector allowing the user to select the set of data that will be provided to the form. When the users selects a persona, the analysis engine 118 obtains the information from identity store 110, and provides it to the browser 102 through browser interface 114. The data is then submitted to site1 104.

The user then navigates to site2 106 and retrieves a form. The same process of transmitting the form identification to mapping table 108 is carried out, but mapping table 108 reports that the form is unknown. Analysis engine 118 then prompts the user to create a mapping of the form. If the user agrees to create the mapping, the user is prompted to identify the identity schema element that should be provided for each of the fields on the form. Some of the fields may not be mappable, and the user can indicate this where applicable. The completed mapping is then transmitted to mapping table 108 through mapping table interface 116, and is used by analysis engine 118 to allow the user to submit the information associated with a persona. The process then continues as above.

In an alternate implementation, the user is prompted to fill in the form instead of creating mapping. The data entered into the form is then analyzed by analysis engine 118 and compared to data stored in identity store 110. The analysis and comparison is used to generate a mapping that is submitted to mapping table 108 as outlined above.

When analysis engine 118 determines that a form is present in a retrieved page it can analyze the form to determine whether a mapping is embedded in the form. If a mapping has been embedded, the mapping can be used without reference to mapping table 108. Additionally, analysis engine 118 can determine that the form is an identity management system form, such as an OpenID login form. In such a case, the identity management system information, such as an OpenID login credential, can be provided.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. An identity agent for use in electronic communications, the agent comprising a browser interface for communicating to a web browser;
an identity store interface for accessing an identity store containing user identity information;
a mapping table interface for communicating to at least one of a plurality of mapping tables to obtain mappings of forms received by the browser and for transmitting agent defined mappings to the at least one mapping table, the mappings associating a field in a form to an element of an identity schema; and
an analysis engine for determining if a page received by the browser contains a form, for requesting mappings from the at least one mapping table for any received form, for filling in forms with user identity information determined in accordance with the obtained mapping and obtained from the identity store, and for generating a mapping for forms not mapped in the mapping table with user input.

2. The identity agent of claim 1 wherein one of the plurality of mapping tables is stored locally.

3. The identity agent of claim 1 wherein the analysis engine includes a mapping generation engine for generating a mapping between an obtained form and at least one element in the identity schema based on an analysis of information input by the user into fields in the form.

4. The identity agent of claim 1 wherein the analysis engine includes a mapping generation engine for generating a mapping between an obtained form and at least one element in the identity schema based on an analysis of the form and a name associated with a field in the form.

5. The identity agent of claim 1 wherein the identity information is organized as a series of personas, each persona having a unique set of identity information.

6. The identity agent of claim 5 wherein the analysis engine includes a persona selector for allowing the user to select one of the series of personas and provide the information associated with the selected persona to the form.

7. The identity agent of claim 6 wherein the persona selector includes an identity management system persona selector for accessing identity information associated with a identity management system, and for presenting the accessed identity information to the user as a persona within the identity agent.

8. The identity agent of claim 7 wherein the identity information associated with an identity management system is selected from a list including information compliant with an OpenID login and information compliant with an InfoCard.

9. The identity agent of claim 1 wherein the analysis engine includes a user interface engine for indicating recognition of a form to the user through the browser.

10. The identity agent of claim 9 wherein the user interface engine includes means to have the browser display a translucent overlay the form indicating the availability of a form mapping.

11. The identity agent of claim 10 wherein the color of the translucent overlay is related to the status of the form.

12. The identity agent of claim 11 wherein one color is reserved to indicate sites suspected of phishing.

13. The identity agent of claim 10 wherein the translucent overlay provides a quick pick list of personas.

14. The identity agent of claim 9 wherein the user interface engine includes means to display a one-click selection list superimposed over the form field.

15. The identity agent of claim 1 wherein the analysis engine includes a password generation engine for generating a site-specific password for filling in password requests on forms.

16. The identity agent of claim 15 wherein the password generation engine includes means to obtain a password from a user, associate the password obtained from the user with a password hint and provide the user the ability to select the password obtained from the user by displaying the associated password hint.

17. The identity agent of claim 15 wherein the analysis engine includes means for storing passwords generated by the password generation engine along with login information associated with the generated password.

18. The identity agent of claim 1 wherein the mapping table includes a reputation based engine for evaluating maps received by the analysis engine.

19. The identity agent of claim 1 wherein the analysis engine includes means for displaying reputation information associated with a user who submitted a received mapping.

20. The identity agent of claim 1 further including a pseudonymous identity information generator interface for receiving pseudonymous identity information from a pseudonymous identity information generator and for associating the received pseudonymous identity information with stored identity information.

21. The identity agent of claim 20 wherein the pseudonymous identity information is selected from a list including a pseudonymous email address, a pseudonymous credit card number, a pseudonymous postal address and a pseudonymous telephone number.

22. The identity agent of claim 20 wherein the received pseudonymous identity information is uniquely associated to the form.

23. The identity agent of claim 1 wherein the identity information stored in the identity store is obtained from a source selected from a list including a form completed by the user, electronic address books, data submitted to already mapped forms, and a browser auto-fill history.

24. The identity agent of claim 1 wherein the obtained mapping is a generic map that is not specific to the page received by the browser and is applicable to a plurality of different pages.
